(19) United States
(12) Patent Application Publication
(10) Pub. No.: US 2014/0070750 A1
(43) Pub. Date: Mar. 13, 2014

(54) Hybrid Motor

(71) Applicant: Wing Leung Fok, Chai Wan (HK)

(72) Inventor: Wing Leung Fok, Chai Wan (HK)

(21) Appl. No.: 14/012,942

(22) Filed: Aug. 28, 2013

(30) Foreign Application Priority Data
Sep. 11, 2012 (CN) 201210334374.8

(51) Int. Cl. H02P 25/02

(52) U.S. Cl. CPC H02P 25/021
USPC 318/494

(57) ABSTRACT

A hybrid motor, having a rotor simultaneously comprising a pair of permanent magnetic poles and a pair of induction magnetic poles. When the magnetic field generated by a stator coil of an electric motor is used to drive the pair of permanent magnetic poles, the electric motor operates as a synchronous motor. When such magnetic field is used to drive the pair of induction magnetic poles, the electric motor operates as an induction motor. According to the operation mode and/or the operation state of the electric motor, a controller (B3) outputs a DC or sine drive signal with continuous and discrete amplitude and changes the drive phase number of the electric motor by changing the switch-on sequence and/or the number of the switching element in the half-bridge drive circuit of the electric motor driver (B4), wherein the half-bridge drive circuit is used to constitute the independent full-bridge drive circuit.

### CROSS-REFERENCE TO RELATED APPLICATION

This application claims priority to China application no. 201210334374.8 filed on Sep. 11, 2012, which is hereby incorporated by reference in its entirety.

### FIELD OF THE INVENTION

This invention relates to the drive technique of a synchronous motor and inductance motor. More particularly, this invention relates to an electric motor driver which can output drive signals with different phase numbers, phases and shapes as well as with a continuous or discrete amplitude. Further, this invention relates to an energy regeneration circuit formed by a function selection switch or by the combination of a function selection switch and a full-bridge rectifier circuit, wherein the function selection switch has a function of selecting a single-phase or multi-phase stator coil.

### BACKGROUND OF THE INVENTION

Motors are widely used in various fields, such as in machinery, petrochemistry and electricity. Generally, a motor comprises of basic parts including a stator, a rotor and a casing, and it can be categorized into direct current motors, synchronous motors and asynchronous motors according to its structure and working principle. In recent years, the performance requirement on the motor has steadily increased with the rapid development of industry. Many inventions related to motor manufacture have been emerging therewith. For example, patent document CN101752921A discloses a rotor which is used in a synchronous motor. Herein, the rotor comprises a plurality of inductive conductors, a first permanent magnet unit and a second permanent magnet unit. In the operational process of the motor, the rotor is firstly rotated by means of the induction motor theory, and then it is rotated at a synchronous speed through magnetic force generated between the conductor of the stator and the permanent magnet of the rotor. Patent document CN101562386B discloses a permanent magnet brushless DC motor, in which the drive circuit of the motor is a three-phase full-bridge circuit. The motor can output six drive pulses and close the six drive outputs when an over current occurs due to its function of over current protection.

At present, the majority of motor systems used in emerging fields (such as electric automobiles and hybrid powered vehicles) include an energy regeneration circuit, which collects reverse electromotive forces generated when the motor is in a non-drive state (i.e. the rotor is rotated by external force) or a phase commutation takes place so as to promote the operational efficiency of the motor system. Patent document CN1237028A discloses a multi-functional permanent magnet DC brushless motor, which consists of an electric motor, a position sensor and a control circuit. In such patent document, each motor winding can be controlled to switch on by turns, and an energy recovery circuit consisting of a backward diode and a load is also included. Patent document CN101889382A discloses a brushless DC motor, in which a circuit for achieving and stopping the power supply for a rotor winding is used. Such circuit is the type providing renewable energy to the power source, such as the circuit using a self-arc extinction component.

However, the following shortages exist in the above-mentioned motor systems: 1) the operation mode of the motor is limited; 2) the electric motor driver can only control the electric motor through changing the frequency and the duty cycle of the drive signal, while it cannot control the shape and the continuity of the drive signal as well as the drive phase number of the electric motor; 3) when the electric motor is driven by a DC signal, it only passively regenerates the reverse electromotive force generated during phase commutation while it cannot actively control phase commutation time according to the operation mode and (or) the operation state of the electric motor in order to achieve a higher operational efficiency for the electric motor; 4) thus the efficiency of the existing energy regeneration circuit is not high because of the above-mentioned reasons.

### SUMMARY OF THE INVENTION

An object of this invention is to provide a hybrid motor with a higher operational efficiency, aiming at the above-mentioned drawbacks and shortages in the prior art.

To solve the above-mentioned technical problems, a hybrid motor is provided in this invention, which comprises an electric motor (EM), an electric motor driver (EMR) and an energy regeneration circuit (ERC). A rotor of the electric motor is comprised of a pair of permanent magnetic poles, or comprised of a pair of permanent magnetic poles and a pair of induction magnetic poles simultaneously.

The electric motor driver comprises a controller and at least one independent full-bridge drive circuit. The latter is constituted by a half-bridge drive circuit to construct the independent full-bridge drive circuit with a single phase, three phases or other phase numbers. In the case of more than one independent full-bridge drive circuit of the electric motor driver, their combination modes are the same or different. Meanwhile, the controller determines outputting a DC or a sine drive signal according to an operation mode and (or) an operation state of the electric motor. When a drive phase number of the electric motor is more than one, a same kind of drive signal is used to drive the electric motor by all the drive circuits.

The independent full-bridge drive circuit is used to drive an independent single phase or multi phases constituted by stator coils, and each group of the independent full-bridge drive circuit has a function selection switch which functions as selecting the independent single-phase or multi-phase stator coil. When the drive phase number of the electric motor is more than one, the controller will adjust the phase difference between the drive signals according to the number of the drive signal. At the same time, it also detects whether the electric motor meets the load requirement through a rotor position sensor and (or) a current/voltage sensing circuit of the electric motor. In this case, it is determined whether to change the drive phase number of the electric motor by changing the switch-on sequence and (or) the number of the switching element in a single or several half-bridge drive circuits which are used to constitute the independent full-bridge drive circuit. The drive signal is applied to the stator coil of the motor, and the magnetic field generated by the stator coil of the motor is used to drive a pair of magnetic poles in the rotor of the electric motor. When the rotor contains both the pair of permanent magnetic poles and the pair of induction magnetic poles, the electric motor can operate in an induction or a synchronous manner; when the rotor only contains the pair of permanent magnetic poles, the electric motor can only operate in a synchronous manner.

The controller determines whether to output the drive signal with a discrete amplitude according to the operation mode and (or) the operation state of the electric motor. The discrete amplitude and the discrete time of the discrete drive signal are determined by the controller based on the operation mode and (or) the operation state of the electric motor.

The energy regeneration circuit is constituted by the function selection switch or by the combination of the function selection switch and a full-bridge rectifier circuit, wherein the function selection switch has a function of selecting the independent single-phase or multi-phase stator coil. The function selection switch is switched on by the controller when all of the half-bridge drive circuits for constituting a single group of the independent full-bridge drive circuit are closed, aiming to collect the current which is generated through the relative movement between the permanent magnet poles in the rotor of the electric motor and the independent single-phase or multi-phase stator coil, wherein such current is supplied to an electrical load or utilized by a storage system.

In the above-mentioned hybrid motor, the electric motor driver and (or) the energy regeneration circuit are (is) applicable to all devices that contain the permanent magnetic pole and convert electrical energy into mechanical energy by way of electromagnetic induction.

In the hybrid motor provided in an embodiment of this invention, the following electric motor driver and energy regeneration circuit are employed, wherein the electric motor driver can output drive signals with different phase numbers, phases and shapes as well as with a continuous or discrete amplitude; the energy regeneration circuit is constituted by the function selection switch or by the combination of the function selection switch and the full-bridge rectifier circuit, and the function selection switch functions as selecting the independent single-phase or multi-phase stator coil. In this way, the motor overcomes the shortage of limited operation mode of the existing motor, and the electric motor driver can control the electric motor not only by changing the frequency and the duty cycle of the drive signal but also by controlling the shape and the continuity of the drive signal and the drive phase number of the electric motor. Moreover, when the electric motor is driven by the DC signal, the phase commutation time can be controlled automatically according to the operation mode and (or) the operation state of the electric motor. Accordingly, the electric motor of the hybrid motor in this invention can have higher operational efficiency.

### BRIEF DESCRIPTION OF THE DRAWINGS

This invention will be further described with reference to the accompanying drawings and embodiments in the following. In the figures, FIGS. 3-8 do not show the current and voltage feedback circuits:

FIGS. 1a and 1b are structural block diagrams for a hybrid motor according to embodiments of the present invention;

FIGS. 2a and 2b are structural diagrams for the electric motor in the hybrid motor according to embodiments of the present invention;

FIG. 3 is a diagram illustrating a first combination of the electric motor driver and the electric motor in the hybrid motor according to an embodiment of present invention;

FIG. 4 is a diagram illustrating a second combination of the electric motor driver and the electric motor in the hybrid motor according to an embodiment of present invention;

FIG. 5 is a diagram illustrating a third combination of the electric motor driver and the electric motor in the hybrid motor according to an embodiment of present invention;

FIG. 6 is a diagram illustrating a fourth combination of the electric motor driver and the electric motor in the hybrid motor according to an embodiment of present invention;

FIG. 7 is a diagram for the energy regeneration circuit applied in the single-phase full-bridge drive circuit in the hybrid motor, in which there are an energy regeneration circuit with DC output, an energy regeneration circuit with AC output and an energy regeneration circuit with both DC and AC outputs from left to right in sequence, according to an embodiment of the present invention;

FIG. 8 is a diagram for the energy regeneration circuit applied in the three-phase full-bridge drive circuit in the hybrid motor, in which there are an energy regeneration circuit with both DC and AC outputs, an energy regeneration circuit with AC output and an energy regeneration circuit with DC output from top to bottom in sequence, according to an embodiment of the present invention;

FIG. 9 is a diagram for the current and voltage sensing circuits applied in the single-phase full-bridge drive circuit and the energy regeneration circuit in the hybrid motor, according to an embodiment of the present invention;

FIG. 10 is a diagram for the current and voltage sensing circuits applied in the three-phase full-bridge drive circuit and the energy regeneration circuit in the hybrid motor, according to an embodiment of the present invention;

FIG. 11a and FIG. 11b are flowcharts illustrating the operation of the system in a hybrid motor. FIG. 11a is a flowchart for selecting the operation mode and different drive signals of the electric motor, and FIG. 11b is a flowchart for changing the drive phase number of the electric motor and outputting some continuous or discrete drive signals, according to an embodiment of the present invention;

FIG. 12 is a diagram for the single-phase sine and DC drive signals outputted in a hybrid motor, wherein such signals have a continuous (top) or discrete (down) amplitude, according to an embodiment of the present invention;

FIG. 13 is a diagram for the three-phase sine and DC drive signals outputted in a hybrid motor, wherein such signals have a continuous (top) or discrete (down) amplitude, according to an embodiment of the present invention.

### DETAILED DESCRIPTION OF SPECIFIC EMBODIMENTS

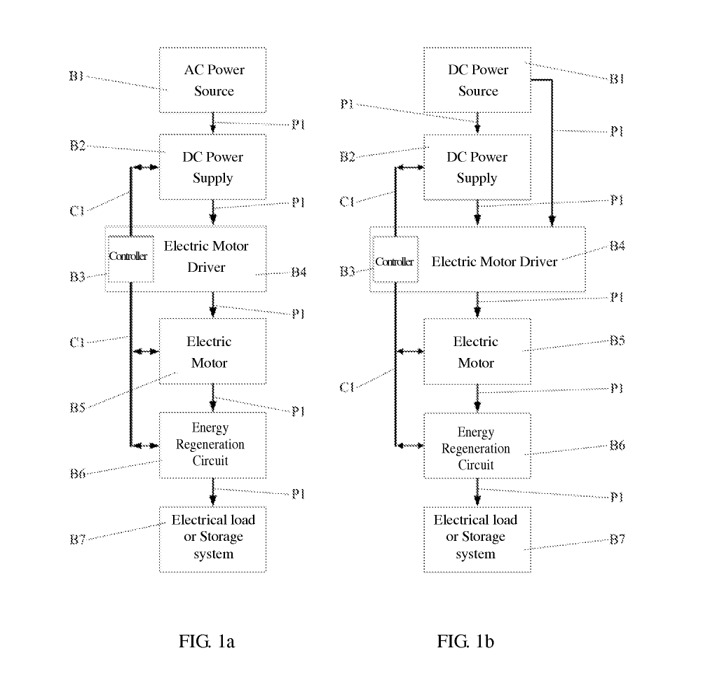

Referring to FIG. 1a, an embodiment of the hybrid motor in this invention mainly comprises of an AC power source B1, a DC power supply B2, an electric motor driver B4 containing a controller B3, an electric motor B5, an energy regeneration circuit B6 and an electrical load or storage system B7. Wherein, the AC power source B1 and the DC power supply B2, the DC power supply B2 and the electric motor driver B4, the electric motor driver B4 and the electric motor B5, the electric motor B5 and the energy regeneration circuit B6, the energy regeneration circuit B6 and the electrical load or storage system B7 are all connected by a power circuit P1, while the controller B3 is connected with the DC power supply B2, the electric motor B5 and the energy regeneration circuit B6 by a control bus C1.

As shown in FIG. 1b, an embodiment of the hybrid motor in this invention mainly comprises of a DC power source B1, a DC power supply B2, an electric motor driver B4 containing a controller B3, an electric motor B5, an energy regeneration circuit B6 and an electrical load or storage system B7. Wherein, the DC power source B1, the DC power supply B2 and the electric motor driver B4 are respectively connected with each other by a power circuit P1. The electric motor driver B4 and the electric motor B5, the electric motor B5 and the energy regeneration circuit B6, as well as the energy regeneration circuit B6 and the electrical load or storage system B7 are connected by a power circuit P1; while the controller B3 is connected with the DC power supply B2, the electric motor B5 and the energy regeneration circuit B6 by a control bus C1.

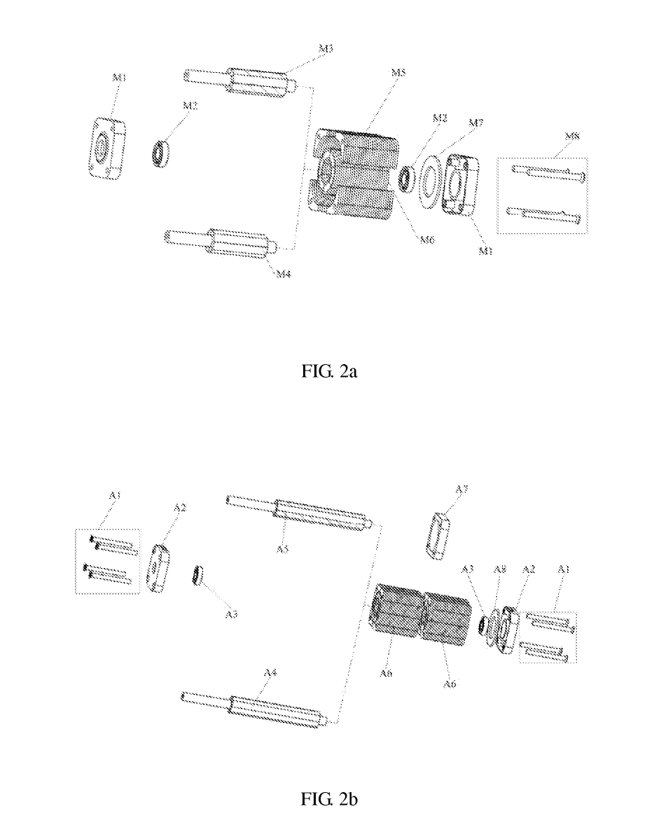

Referring to FIG. 2a, in an embodiment of the hybrid motor in this invention, a first type of electric motor is comprised of motor fixing components (M1, M8), a bearing M2, a rotor M3 including both a pair of induction magnetic poles and a pair of permanent magnetic poles or a rotor M4 including only a pair of permanent magnetic poles (either M3 or M4), a stator core M5, a stator coil M6 and a rotor position sensor M7. Wherein, the stator coil M6 comprises six stator coils in uniform distribution, of which the adjacent ones are apart from each other by 60°. Every two stator coils which are apart by 180° constitute one phase via a series connection. The total phase number of the motor stator is three, and the three phases may be independent from each other or connected in the form of a star or a delta.

Referring to FIG. 2b, in an embodiment of the hybrid motor in this invention, a second type of electric motor is comprised of motor fixing components (A1, A2, A7), a bearing A3, a rotor A5 including both a pair of induction magnetic poles and a pair of permanent magnetic poles or a rotor A4 including only a pair of permanent magnetic poles (either A5 or A4), a motor stator A6 and a rotor position sensor A8. Wherein, two stator cores M5 and stator coils M6 of the first type of electric motor in FIG. 2a are connected in series by the stator connecting component A7 to constitute the stator and stator coil M6. Herein, the total phase number of the motor stator A6 is six, and the connection mode between the phases in the two stator coils M6 of the stator can be the same or different. For example, one stator is connected in the form of a star or a delta, while the other one is connected in the form of three independent phases.

There are two optional rotors in the above-mentioned two electric motors:

(1) The rotor (M4, A4) comprises four pairs of permanent magnetic poles, wherein each pair of the magnetic poles is apart by 45°.

(2) The rotor (M3, A5) comprise two pairs of permanent magnetic poles and two pairs of induction magnetic poles, wherein the pair of permanent magnetic poles is apart from the pair of induction magnetic poles by 45°.

Therefore, there are four different combinations of the electric motor in the embodiment of the hybrid motor in this invention. In the above-mentioned four combinations of the electric motor for illustration, the sensing of the rotor position can also be obtained without a sensor except that it is obtained through the position sensor (M7, A8) in the above-mentioned embodiment. For example, it can be obtained through a field oriented control (FOC).

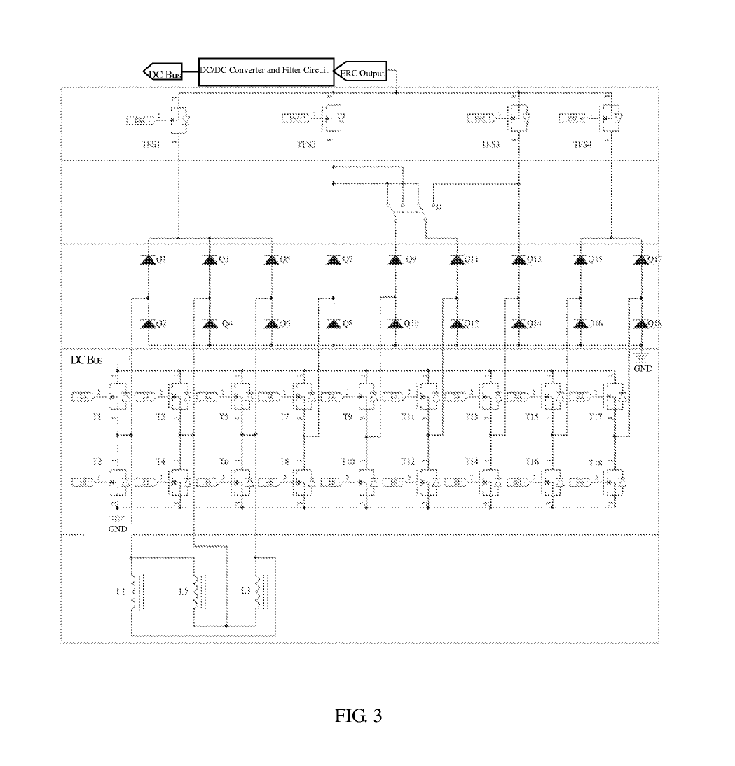

Referring to FIG. 3 to FIG. 6, in an embodiment of the hybrid motor in this invention, drive phases L1, L2 and L3 in FIG. 3 are three drive phases of the electric motor B5 in FIGS. 1a and 1b. In the example of FIG. 3, every phase is constituted by two stator coils that are connected in series and apart from each other by 180°. Control signals 1A, 1B and the like are the control signals outputted by the controller, so control signals 1A to 9A and 1B to 9B are connected to the controller.

The electric motor driver B4 in FIGS. 1a and 1b comprises the following components in FIG. 3: metal oxide semiconductor field effect transistors (MOSFET) T1-T18 and diodes Q1-Q18, wherein such components form nine groups of half-bridge drive circuits and nine groups of half-bridge rectifier circuits. The MOSFETs T1-T6 and the diodes Q1-Q6 form one group of an independent three-phase full-bridge drive circuit and three-phase full-bridge rectifier circuit, and TFS1 is used as a function selection switch of the independent drive circuit. The MOSFETs T7-T14 and the diodes Q7-Q14 can be combined by a combination switch S1 into two groups of independent single-phase full-bridge drive circuits or into one group of an independent three-phase full-bridge drive circuit and one independent half-bridge drive circuit from four groups of half-bridge drive circuits comprising the MOSFETs T7-T14. Herein, switches TFS2 and TFS3 are used as the function selection switches of the two groups of independent drive circuits. The MOSFETs T15-T18 and the diodes Q15-Q18 are combined into one group of an independent single-phase full-bridge drive circuit and a single-phase full-bridge rectifier circuit, and TFS4 is used as the function selection switch of the independent full-bridge drive circuit (TFS stands for transistor function selection, so it is named as the function selection switch).

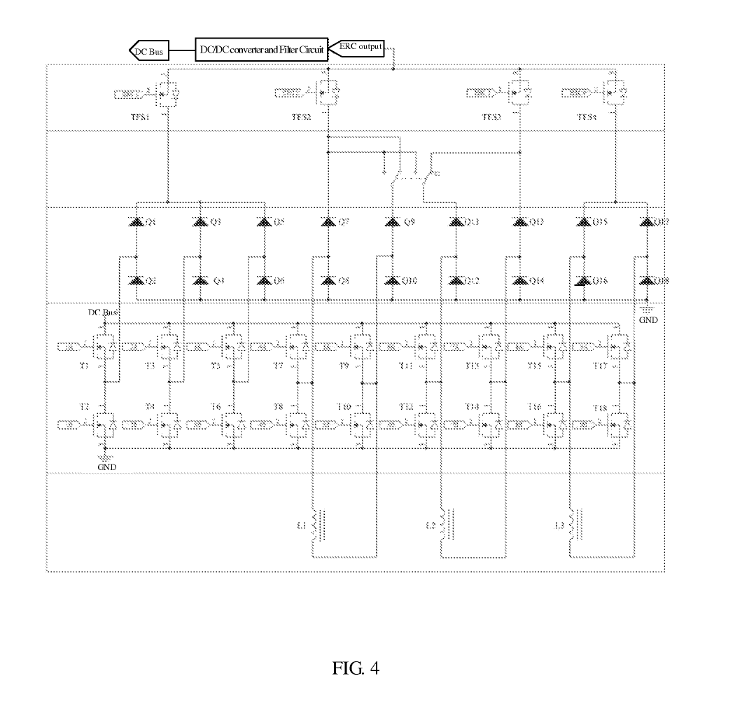

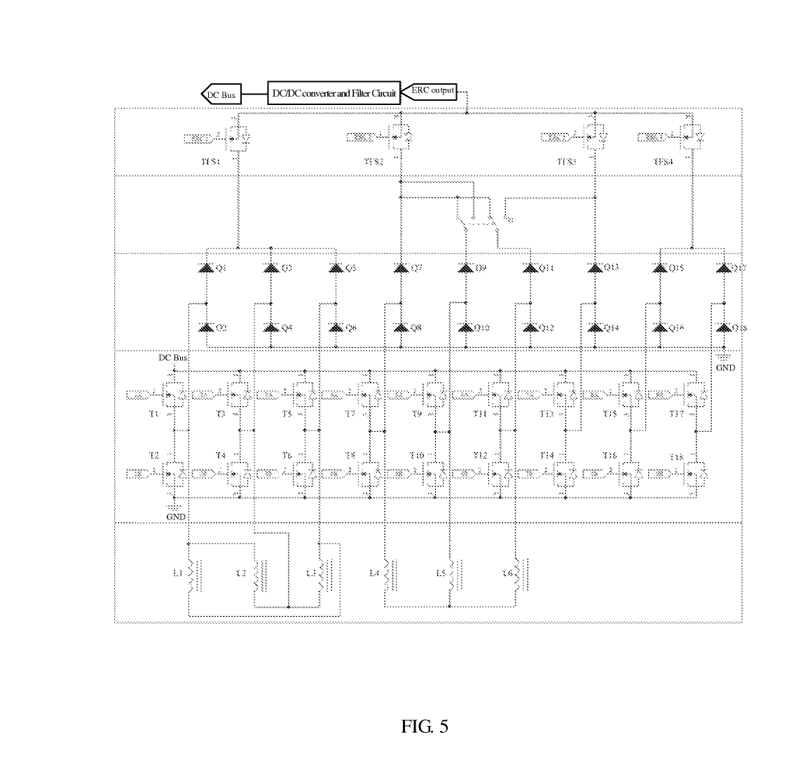

FIG. 3 is a diagram illustrating the electric motor shown in FIG. 2a connected to an exemplary example circuit by way of three-phase connection. FIG. 4 is a diagram illustrating the electric motor shown in FIG. 2a connected to an exemplary example circuit by way of independent three-phase connection. Herein, two connection modes of the first type of electric motor can be seen from FIG. 3 and FIG. 4.

Similarly, FIG. 5 is a diagram illustrating the electric motor shown in FIG. 2b connected to an exemplary example circuit by way of three-phase connection.

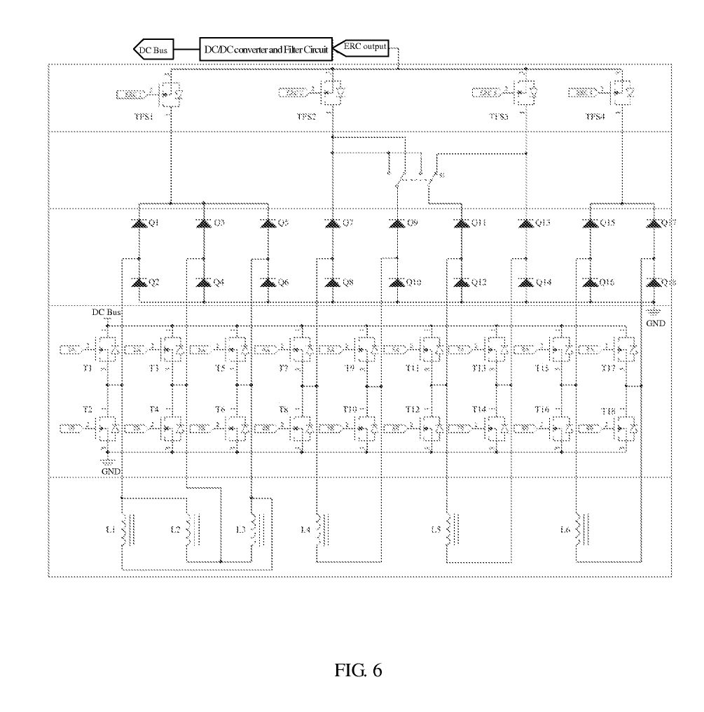

FIG. 6 is a diagram illustrating the electric motor shown in FIG. 2b connected to an exemplary example circuit by way of three-phase connection and independent three-phase connection. Meanwhile, both FIG. 5 and FIG. 6 operate to show the two connection modes of the second type of electric motor.

In an embodiment of the hybrid motor in this invention, the controller drives the electric motor by controlling the on and off of the switching element (which is the MOSFET in this example) of the half-bridge drive circuit in the electric motor driver. The controller determines outputting a DC or a sine drive signal according to the operation mode and (or) the operation state of the electric motor. When the drive phase number of the electric motor is more than one, the controller adjusts the phase difference between the drive signals according to the number of the drive signal (for example: the phase difference of a three-phase sine drive signal is 120°, and the phase difference of a two-phase sine drive signal is 90° or 180°). Meanwhile, the controller detects whether the electric motor meets the load requirement through a rotor position sensor and (or) a current/voltage sensing circuit of the electric motor. In this case, whether to change the drive phase number of the electric motor is determined by changing the switch-on sequence and (or) the number of the switching element in a single or several half-bridge drive circuits which are used to constitute the independent full-bridge drive circuit. The controller also determines whether to output the drive signal with a discrete amplitude according to the operation mode and (or) the operation state of the electric motor, wherein the discrete amplitude and the discrete time of the discrete drive signal are determined by the controller based on the operation mode and (or) the operation state of the electric motor. When the half-bridge drive circuits constituting the single group of independent full-bridge drive circuit are all closed, the function selection switch of the independent full-bridge drive circuit is switched on by the controller. In this case, the independent single-phase or multi-phase stator coil driven by the independent full-bridge drive circuit is changed from a drive coil to an induction coil, aiming to collect the current which is generated through the relative movement between the permanent magnet of the rotor in the electric motor and the single-phase or multi-phase stator coil. The current is injected into the DC bus once again by passing through the rectifier circuit and a DC regulator so that it can be utilized by the electric motor driver once more.

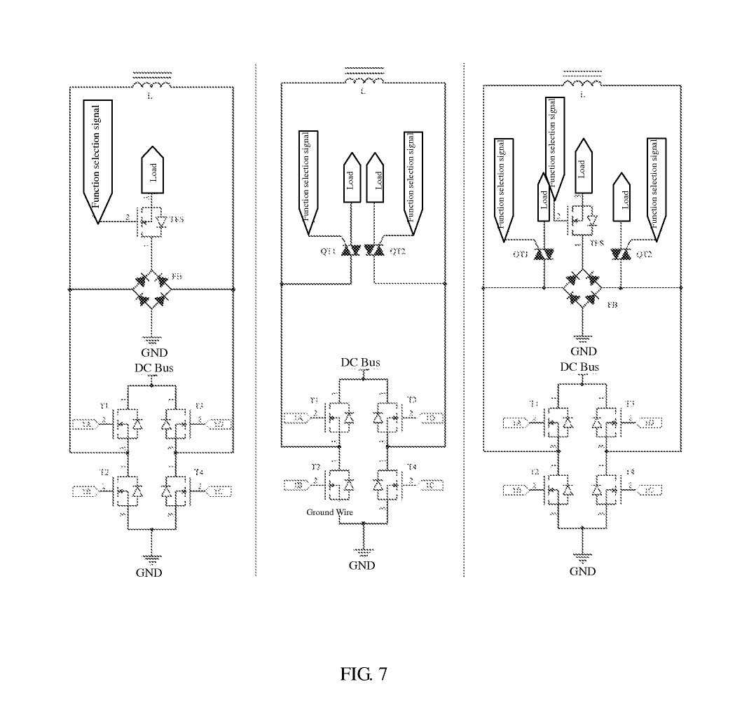

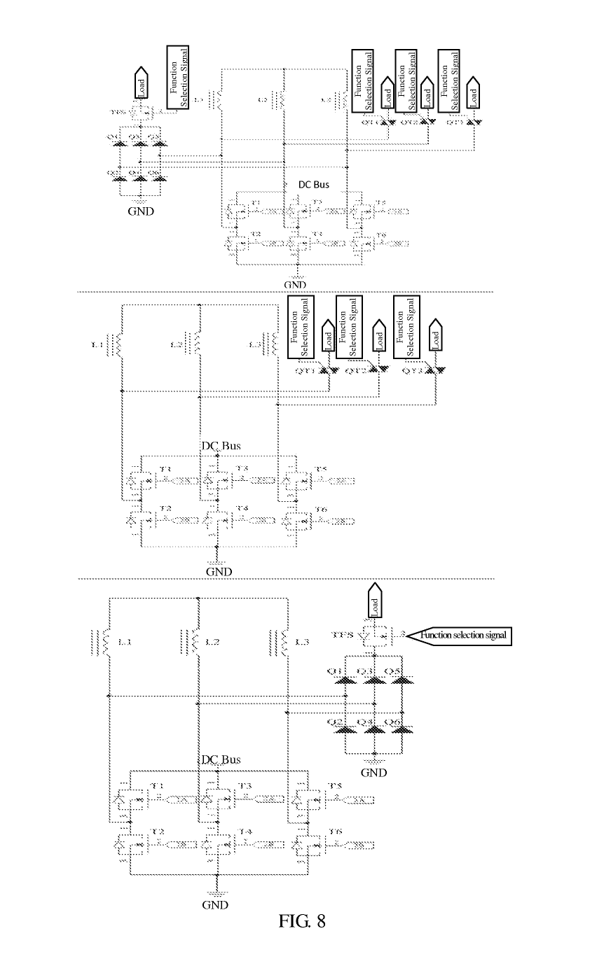

Illustrated in FIG. 7 and FIG. 8, are the combination modes of DC output, AC output and AC-DC output for the energy regeneration circuit in the hybrid motor according to an embodiment of this invention.

As shown in FIG. 7, the MOSFETs T1-T4 constitutes one group of a single-phase full-bridge drive circuit. Phase L is one independent phase of the electric motor that is formed by a single or several stator coils in series, in parallel or in serial-parallel. FB is a full-bridge rectifier circuit, while TFS, QT1 and QT2 are function selection switches functioning as selecting one independent phase of the electric motor. The function selection signal is the control signal outputted by the controller. Herein, FIG. 7 operates to show three kinds of combination modes when the energy regeneration circuit is applied to the independent signal-phase full-bridge drive circuit.

As shown in FIG. 8, the MOSFETs T1-T6 constitutes one group of the three-phase full-bridge drive circuit. Phases L1, L2 and L3 are three independent phases of the electric motor formed by the stator coil. The diodes Q1-Q6 constitute one group of the three-phase full-bridge rectifier circuit. Herein, TFS, QT1, QT2 and QT3 are function selection switches functioning as selecting the three independent phases of the electric motor. The function selection signal is the control signal outputted by the controller. Herein, FIG. 8 operates to show three kinds of combination modes when the energy regeneration circuit is applied to the independent three-phase full-bridge drive circuit.

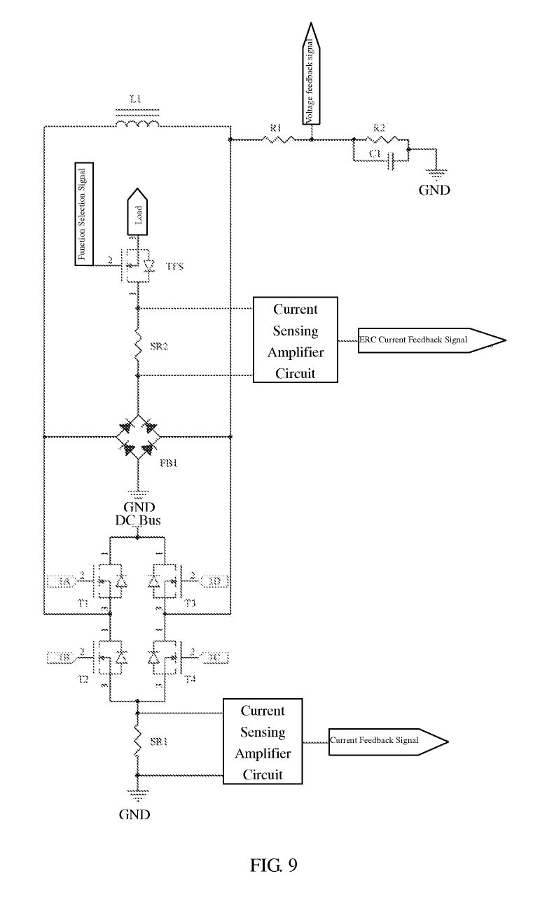

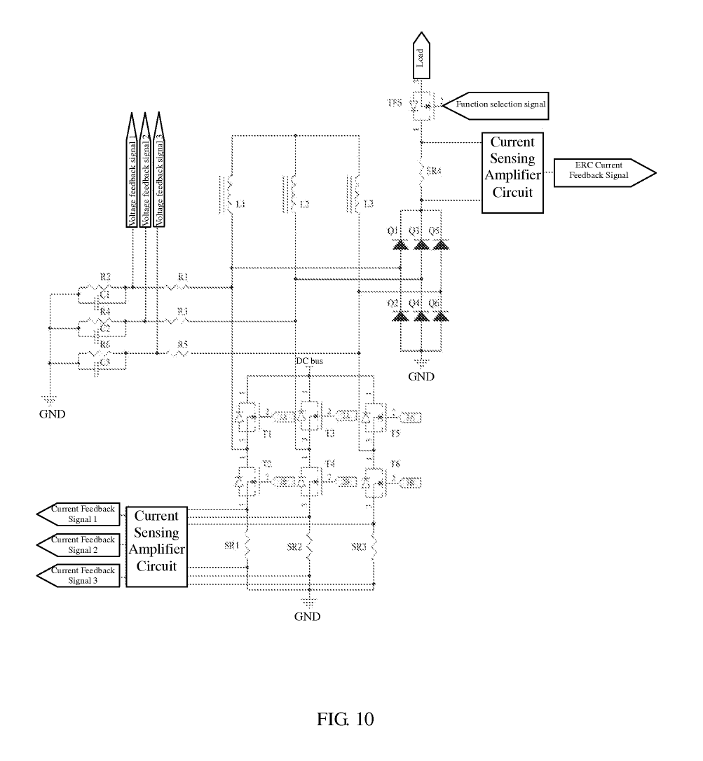

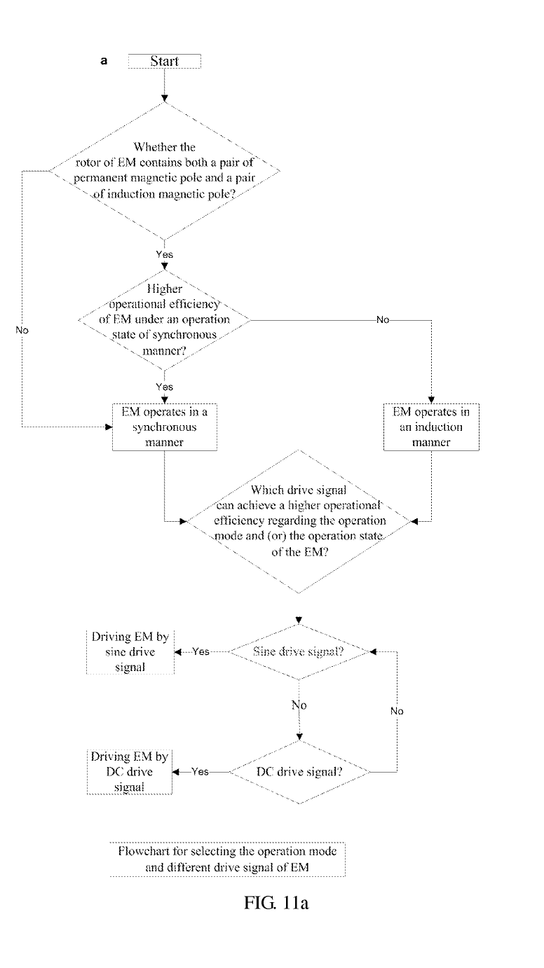

Referring to FIG. 9 and FIG. 10, the electric motor controller detects whether the electric motor meets the load requirement through a rotor position sensor and (or) a current/voltage sensing circuit of the electric motor. In FIG. 9, SR1 and SR2 are shunt resistors for sensing the currents of the full-bridge drive circuit (SR1) and the energy regeneration circuit (SR2). R1, R2 and C1 are used to sense the voltage of L1. In FIG. 10, SR1, SR2, SR3 and SR4 are shunt resistors for sensing the currents of the three-phase full-bridge drive circuit (SR1, SR2, SR3) and the energy regeneration circuit (SR4). R1, R2, R3, R4, R5, R6, C1, C2, and C3 are used to sense the voltages of L1, L2 and L3. FIG. 9 and FIG. 10 are used to supplement the omitted current and voltage sensing circuits in FIGS. 3-8.

In accordance with the embodiments of the hybrid motor in this invention, the above-mentioned different electric motors, electric motor drivers and energy regeneration circuits can be included herein, wherein different combinations thereof can constitute different embodiments of the hybrid motor in this invention.

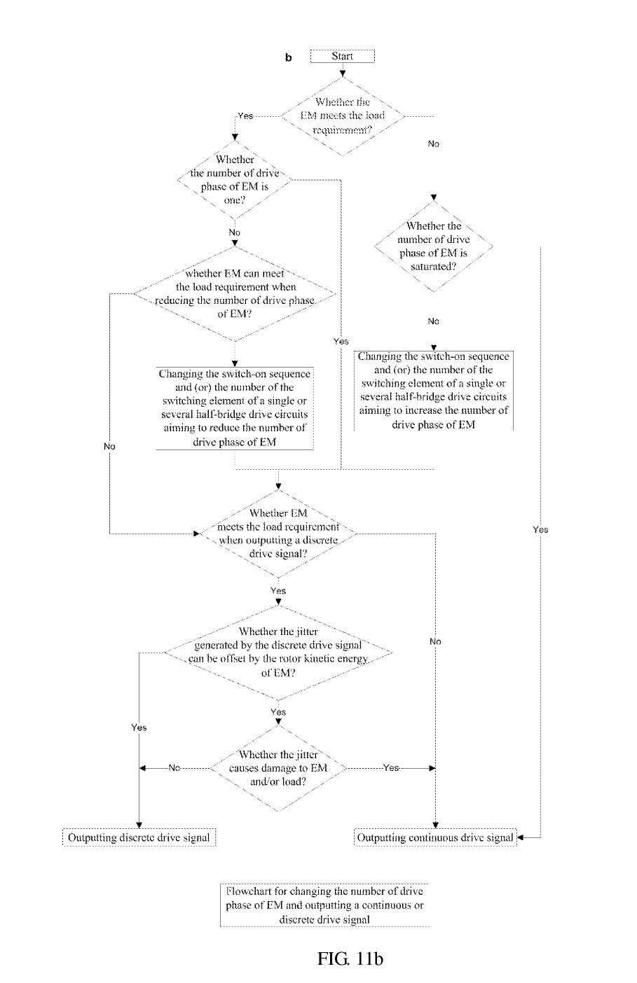

FIGS. 11a and 11b are flowcharts for the operation of the hybrid motor system in this invention. In particular, FIG. 11a is a flowchart for selecting the operation mode and different drive signals of the electric motor. When the first kind of rotor (M4, A4) (i.e. the one only containing a pair of permanent magnetic poles) is employed in the electric motor in this embodiment, the electric motor can only operate as a synchronous motor. When the second kind of rotor (M3, A5) (i.e. the one containing both a pair of permanent magnetic poles and a pair of induction magnetic poles simultaneously) is employed in the electric motor in this embodiment, the controller will detect the operation state of the electric motor and further judge which kind of operation mode can achieve a higher operational efficiency, aiming to determine that the magnetic field generated by the stator coil is used to drive the pair of induction magnetic poles or the pair of permanent magnetic poles in the rotor. When the electric motor operates as an induction motor, it is firstly started by means of a synchronous motor, in which case the controller of the electric motor driver only drives the pair of induction magnetic poles of the rotor according to the rotor position of the electric motor. When the electric motor operates as a synchronous motor, the controller drives the electric motor as the same as driving a 4-pole permanent magnet motor, so the permanent magnetic pole and the induction magnetic pole of the rotor can simultaneously drive the rotor to rotate. However, in this case, when the rotor reaches a synchronous speed, the induction magnetic pole therein will stop driving the rotor to rotate due to the characteristics of the induction motor. In addition, according to the operation mode and (or) the operation state of the electric motor, the controller judges which kind of drive signal drives the electric motor in a more efficient way and further determines whether to output a DC or a sine drive signal correspondingly. Compared to the sine drive signal, the DC drive signal can generate higher torque under the same peak current. It also generates some torque jitter simultaneously, which however is offset by the rotor kinetic energy during the high-speed operation of the motor. For these reasons, the DC drive signal is more appropriate for driving the electric motor than the sine drive signal when the motor needs a high-speed and high torque. FIG. 11b is a flowchart for changing the drive phase number of the electric motor and outputting a continuous or discrete drive signal.

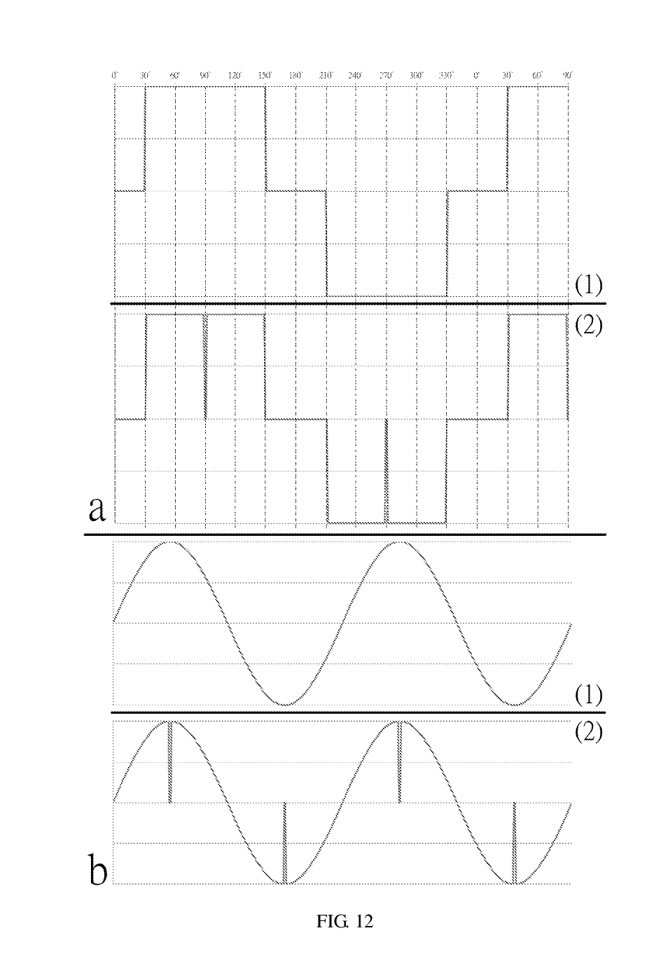

Referring to FIG. 12, showing respective continuous (1) and discrete (2) signals, when the electric motor driver outputs the single-phase sine or DC drive signal with discrete amplitude, each cycle of the above-mentioned drive signal is 360°. When the drive signal is close to 90° or 270°, the controller will close the single-phase full-bridge drive circuit for driving the electric motor and switch on the function selection switch at the same time.

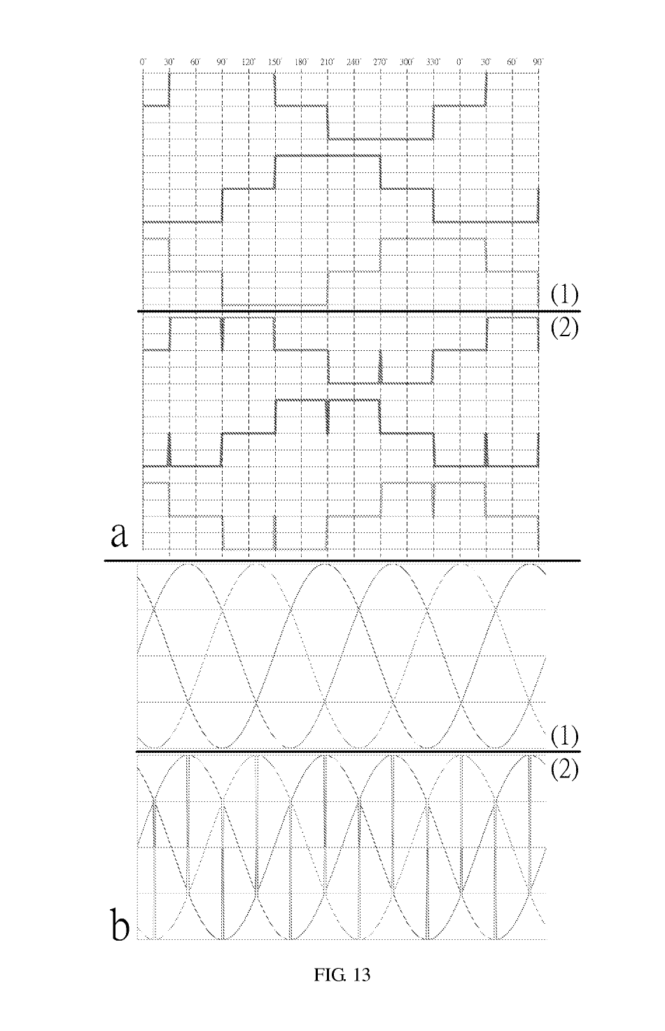

Referring to FIG. 13, showing respective continuous (1) and discrete (2) signals, when the electric motor is driven by a three-phase DC drive signal, the cycle of the three-phase DC drive signal is 360°, and their phase difference is 60°. Herein, a phase commutation is carried out on such drive signal every 60°, and the phase commutation time determines the extent of the rotor jitter of the motor. When the controller outputs a DC drive signal with discrete amplitude, the controller closes the half-bridge drive circuit which is driving the electric motor as getting close to the phase commutation, while it also delays to switch on and further closes the remaining two-phase half-bridge drive circuit in advance. In this way, when the controller closes the half-bridge drive circuit which is driving the electric motor, every half-bridge drive circuit of the three-phase full-bridge drive circuit is in the closing state. At this time, the controller also switches on the function selection switch of the independent drive circuit. When the controller outputs a sine drive signal with discrete amplitude, the controller closes the three-phase full-bridge drive circuit, as the drive signal per phase is getting close to its peak value, and switches on the function selection switch simultaneously.

The hybrid motor provided in this invention comprises the electric motor B5, the electric motor driver B4 and the energy regeneration circuit B6, wherein the rotor can simultaneously comprise the pair of permanent magnetic poles and the pair of induction magnetic poles. When the magnetic field generated by the stator coil of the electric motor is used to drive the pair of permanent magnetic poles of the rotor, the electric motor operates as the synchronous motor; but when the magnetic field is used to drive the pair of induction magnetic poles of the rotor, the electric motor will operate as the induction motor. According to the operation mode and (or) the operation state of the electric motor, the controller outputs the DC or sine drive signal with discrete or continuous amplitude and changes the drive phase number of the electric motor by changing the switch-on sequence and (or) the number of the switching element in the half-bridge drive circuits of the electric motor driver B4, wherein the half-bridge drive circuits are used to constitute the independent full-bridge drive circuit. Such energy regeneration circuit and the hybrid motor are applicable to all motors that contain the permanent magnetic pole and convert the electrical energy into the mechanical energy by way of electromagnetic induction, wherein the energy regeneration circuit is comprised of the function selection switch or by the combination of the function selection switch and the full-bridge rectifier circuit, and the hybrid motor comprises the electric motor driver and the electric motor for achieving the above-mentioned functions.

In addition, the above-mentioned electric motor driver or the energy regeneration circuit is not limited to use in the hybrid motor in such embodiments. Instead, they are applicable to all devices that contain the permanent magnetic pole and convert electrical energy into mechanical energy by way of electromagnetic induction.

The ordinary skilled in the art may make various changes and modifications to the above-mentioned description according to the technical solution and technical conception of this invention, and all these changes and modifications should fall within the scope of the appended claims of this invention.

What is claimed is:

1. A hybrid motor comprising:
an electric motor (B5), an electric motor driver (B4) and an energy regeneration circuit (B6); wherein, the electric motor driver (B4) comprises
one or more independent full-bridge drive circuits and a controller (B3);
each independent full-bridge drive circuit is used to drive an independent single-phase or multi-phase stator coil, and each independent full-bridge drive circuit comprises at least two half-bridge drive circuits constituting the independent full-bridge drive circuit with a single phase, three phases or other phases;
each independent full-bridge drive circuit is provided with a function selection switch which has a function of selecting an independent stator coil,
when a drive phase number of the electric motor (B5) is more than one, the controller (B3) detects whether the electric motor (B5) meets a load requirement through a rotor position sensor and/or a current or voltage sensing circuit of the electric motor (B5), so as to determine whether to change the drive phase number of the electric motor (B5) by changing a switch-on sequence and/or a number of a switching element in the at least two half-bridge drive circuits which constitute the independent full-bridge drive circuit.

2. The hybrid motor according to claim 1, wherein when the drive phase number of the electric motor (B5) is more than one, a cycle of each drive signal is 360°; wherein the controller (B3) adjusts a phase difference between each drive signal according to the drive phase number of the electric motor (B5).

3. The hybrid motor according to claim 1, wherein the controller (B3) determines outputting a DC drive signal or a sine drive signal according to an operation mode and/or an operation state of the electric motor (B5); when the drive phase number for driving the electric motor (B5) is more than one, a same kind of drive signal is used to drive the electric motor (B5) by each independent full-bridge drive circuit.

4. The hybrid motor according to claim 1, wherein when an independent single-phase full-bridge drive circuit in the electric motor driver (B4) outputs a single-phase sine or DC drive signal with a discrete amplitude, a cycle of the drive signal is 360°; when the drive signal is close to 90° or 270°, the controller (B3) closes all the half-bridge drive circuits which constitute the independent single-phase full-bridge drive circuit and switches on the function selection switch of the independent single-phase full-bridge drive circuit at the same time.

5. The hybrid motor according to claim 4, wherein when a single group of the independent full-bridge drive circuit having other phases in the electric motor driver (B4) outputs a discrete drive signal, the controller (B3) chooses to close all the half-bridge drive circuits which constitute the independent full-bridge drive circuit at an optimal time according to a phase difference between the drive signals for driving the electric motor (B5) and an operation mode and/or an operation state of the electric motor (B5), and the function selection switch of the independent full-bridge drive circuit is also switched on by the controller (B3) simultaneously.

6. The hybrid motor according to claim 4, wherein the discrete amplitude and a discrete time of a discrete drive signal are determined by the controller (B3) based on an operation mode and/or an operation state of the electric motor (B5).

7. The hybrid motor according to claim 5, wherein the discrete amplitude and a discrete time of the discrete drive signal are determined by the controller (B3) based on the operation mode and/or the operation state of the electric motor (B5).

8. The hybrid motor according to claim 1, wherein the function selection switch comprises a metal oxide semiconductor field effect transistor or a component with the same function for changing the independent single-phase or multi-phase stator coil to an induction coil;
wherein, only when all the half-bridge drive circuits of the independent full-bridge drive circuit for driving the independent single-phase or multi-phase stator coil are closed, the controller (B3) switches on the function selection switch of the independent full-bridge drive circuit, aiming to collect a current which is generated through a relative movement between a permanent magnet of a rotor and the independent single-phase or multi-phase stator coil, wherein such current is supplied to an electrical load or utilized by a storage system (B7).

9. The hybrid motor according to claim 4, wherein the function selection switch comprises a metal oxide semiconductor field effect transistor or a component with the same function for changing the independent single-phase or multi-phase stator coil to an induction coil;
wherein, only when all the half-bridge drive circuits of the independent full-bridge drive circuit for driving the independent single-phase or multi-phase stator coil are closed, the controller (B3) switches on the function selection switch of the independent full-bridge drive circuit, aiming to collect a current which is generated through a relative movement between a permanent magnet of a rotor and the independent single-phase or multi-phase stator coil, wherein such current is supplied to an electrical load or utilized by a storage system (B7).

10. The hybrid motor according to claim 5, wherein the function selection switch comprises a metal oxide semiconductor field effect transistor or a component with the same function for changing the independent single-phase or multi-phase stator coil to an induction coil;
wherein, only when all the half-bridge drive circuits of the independent full-bridge drive circuit for driving the independent single-phase or multi-phase stator coil are closed, the controller (B3) switches on the function selection switch of the independent full-bridge drive circuit, aiming to collect a current which is generated through a relative movement between a permanent magnet of a rotor and the independent single-phase or multi-phase stator coil, wherein such current is supplied to an electrical load or utilized by a storage system (B7).

11. The hybrid motor according to claim 1, wherein the energy regeneration circuit (B6) comprises the function selection switch or a combination of both the function selection switch and a full-bridge rectifier circuit, wherein the energy regeneration circuit acts upon the controller (B3) during a switch-on of the function selection switch.

12. The hybrid motor according to claim 2, wherein the energy regeneration circuit (B6) comprises the function selection switch or a combination of both the function selection switch and a full-bridge rectifier circuit, wherein the energy regeneration circuit acts upon the controller (B3) during a switch-on of the function selection switch.

13. The hybrid motor according to claim 3, wherein the energy regeneration circuit (B6) comprises the function selection switch or a combination of both the function selection switch and a full-bridge rectifier circuit, wherein the energy regeneration circuit acts upon the controller (B3) during a switch-on of the function selection switch.

14. The hybrid motor according to claim 4, wherein the energy regeneration circuit (B6) comprises the function selection switch or a combination of both the function selection switch and a full-bridge rectifier circuit, wherein the energy regeneration circuit acts upon the controller (B3) during a switch-on of the function selection switch.

15. The hybrid motor according to claim 5, wherein the energy regeneration circuit (B6) comprises the function selection switch or a combination of both the function selection switch and a full-bridge rectifier circuit, wherein the energy regeneration circuit acts upon the controller (B3) during a switch-on of the function selection switch.

16. The hybrid motor according to claim 6, wherein the energy regeneration circuit (B6) comprises the function selection switch or a combination of both the function selection switch and a full-bridge rectifier circuit, wherein the energy regeneration circuit acts upon the controller (B3) during a switch-on of the function selection switch.

17. The hybrid motor according to claim 7, wherein the energy regeneration circuit (B6) comprises the function selection switch or a combination of both the function selection switch and a full-bridge rectifier circuit, wherein the energy regeneration circuit acts upon the controller (B3) during a switch-on of the function selection switch.

18. The hybrid motor according to claim 8, wherein the energy regeneration circuit (B6) comprises the function selection switch or a combination of both the function selection switch and a full-bridge rectifier circuit, wherein the energy regeneration circuit acts upon the controller (B3) during a switch-on of the function selection switch.

19. The hybrid motor according to claim 9, wherein the energy regeneration circuit (B6) comprises the function selection switch or a combination of both the function selection switch and a full-bridge rectifier circuit, wherein the energy regeneration circuit acts upon the controller (B3) during a switch-on of the function selection switch.

20. The hybrid motor according to claim 10, wherein the energy regeneration circuit (B6) comprises the function selection switch or a combination of both the function selection switch and a full-bridge rectifier circuit, wherein the energy regeneration circuit acts upon the controller (B3) during a switch-on of the function selection switch.
